(19) United States
(12) Patent Application Publication
(10) Pub. No.: US 2025/0339930 A1
(43) Pub. Date: Nov. 6, 2025

(54) Drilling Technique Using Adaptive Control Motors

(71) Applicant: SETI-TEC, COLLEGIEN (FR)

(72) Inventors: Emmanuel Martineau, HERBERGEMENT (FR); Etienne Petit, CHELLES (FR)

(21) Appl. No.: 18/993,250

(22) PCT Filed: Jul. 10, 2023
(86) PCT No.: PCT/EP2023/069063

§ 371 Date: Jan. 10, 2025

(30) Foreign Application Priority Data
Jul. 12, 2022 (FR) 2207174

(51) Int. Cl. B23Q 15/12; B23B 35/00

(52) U.S. Cl. CPC B23Q 15/12; B23B 35/00

(57) ABSTRACT

A method for drilling using a cutting tool capable of being rotated and translated about/along the same axis by a drilling device, which includes a cutting motor capable of causing the cutting tool to rotate about the axis and a feed motor capable of causing the cutting tool to translate along the axis. The method includes adapting control of the motors. The speeds of the cutting motor and the feed motor are controlled as long as the torque and the thrust are below the torque threshold and the thrust threshold, respectively; when the torque or the thrust reaches or exceeds the torque threshold or the thrust threshold, the current of the motor generating the torque or the thrust whose threshold has been exceeded is controlled, whereas the other motor is still subject to speed control, so the feed per revolution of the cutting tool is equal to a predetermined value.

### 1. CROSS-REFERENCE TO RELATED APPLICATIONS

This Application is a Section 371 National Stage Application of International Application No. PCT/EP2023/069063, filed Jul. 10, 2023, and published as WO 2024/013107 A1 on Jan. 18, 2024, not in English, which claims priority to and the benefit of French Patent Application No. 2207174, filed Jul. 12, 2022, the contents of which are incorporated herein by reference in their entireties.

### 2. FIELD OF THE INVENTION

The field of the invention is that of drilling methods and devices implemented to drill elements to be drilled, in particular those made up of a stack of layers of different materials.

### 3. PRIOR ART

Drilling is commonly carried out using drilling devices, particularly in the aerospace industry, to make holes through elements to be drilled, which may sometimes be made up of several layers of different materials.

When drilling an element, it may be necessary to vary the cutting conditions to optimise drilling. This could be the case, for example:
when the element to be drilled is made up of a stack of layers of different materials, each of which needs to be drilled under suitable cutting conditions, in particular to ensure the quality of the drilling, avoid damage to the cutting tool, etc.
when drilling a low conicity hole, intended to receive a taperlock screw, using a conical cutting tool insofar as the quantity of material removed, and therefore the cutting forces, increase with the depth of drilling;
in a drilling-milling operation, where the cutting tool has a first cylindrical part followed by a conical part, the drilling operation begins by drilling a cylindrical hole until the cutting tool emerges from the wall, then as the cutting tool continues to move forward, the conical part of the cutting tool makes a countersink at the entrance to the hole;
when drilling under lubrication, the injection of lubricant may be unintentionally variable due to a lack of perfect control and/or for unknown reasons, so that its effect is also variable, resulting in a variation in the cutting forces and therefore the need to adapt the cutting conditions accordingly in order to guarantee the quality of the drilling and preserve the condition of the cutting tool and the drilling machine;
cutting forces vary according to the level of friction on the margins of the cutting tool, which leads to variations in cutting forces and the need to adapt cutting conditions accordingly in order to ensure the quality of the drilling.

The occurrence of various events during a drilling operation on an element to be drilled, which may or may not be made up of a stack of several layers of different materials, may thus lead to the need to modify the cutting conditions during drilling in order to optimise drilling in terms of quality and/or preservation of the material used for this purpose.

The cutting parameters are generally:
the tangential speed of the cutting tool tips and the cutting tool rotation frequency in rpm;
the feed speed of the cutting tool in mm/min;
the feed per revolution in mm/revolution, which reflects the proportional relationship between the rotation frequency and the feed speed of the cutting tool.

The drilling machines with controlled cutting parameters have been developed with this in mind.

A drilling machine of this type may for example comprise a feed motor and a cutting motor, generally synchronous with permanent magnets, which are connected, by means of a transmission, to a spindle rotated and translated about/along the same axis and capable of causing a cutting tool to be driven into motion.

In some cases, this transmission can be configured in such a way that:
the rotation frequency of the cutting tool is proportional to the rotation frequency of the cutting motor;
the feed speed of the cutting tool is proportional to the rotation frequency of the feed motor.

Patent document FR-B1-3 000 693 describes a drilling machine of this type.

During a drilling operation, a cutting tool is subjected to various cutting forces, namely:
cutting torque;
axial thrust;
friction on the margins contributing to torque and thrust, which is high for conical cutting tools and lower for standard cutting tools.

A drilling machine with controlled cutting parameters can also include means for evaluating all or some of these forces, in particular means for measuring a load value representative of the torque and/or thrust applied to the cutting tool. Such measuring means may in particular be such as those described for example in patent document FR-B1-3 058 342.

The load value measured on the drill bit can be:
the measurement of a torque sensor placed on the transmission between the cutting motor of the cutting tool and the cutting tool, translating the torque applied to the cutting tool;
the measurement of a force sensor placed on the spindle, translating the axial thrust on the cutting tool;
the measurement of the power or current consumed by the cutting motor of the cutting tool, translating the torque applied to the cutting tool (taking into account the transmission ratio in the case of a two-speed drilling machine);
the measurement of the power or current consumed by the feed motor of the cutting tool, reflecting the thrust applied to the cutting tool.

A drilling machine with controlled cutting parameters can also include means for controlling and powering motors.

These powering means enable the motors to be controlled in terms of speed with predetermined speed setpoints.

The controlling means are able to control the drilling in such a way that the cutting parameters used are adapted to the materials encountered during a drilling. When drilling an element comprising a stack of layers of different materials, the nature of the layers and their stacking order may be known. In this case, monitoring the load on the drill bit is used to detect changes in material and to adapt the cutting conditions accordingly. When the materials to be drilled are known, but not the stacking order, it is necessary to use an algorithm that is capable to detect changes in material and to identify the nature of the new material encountered. Patent document FR-B1-3058342 proposes a method that enables this.

During the drilling operation of the or each material of an element to be drilled, it is desirable that the cutting forces remain stable and moderate to avoid excessive heating of the cutting tool, the element to be drilled and the drilling machine, and thus preserve their service life and the quality of the holes.

Patent document FR-B1-3 058 342 describes a control method for automatically adapting the cutting parameters to the different materials encountered during the drilling of an element made up of a stack of several layers of different materials.

This technique is interesting in that it makes it possible to control the cutting forces resulting from the successive drilling of different materials.

However, this technique is complex to implement and is not suitable for managing a continuous variation in cutting forces resulting not from a change in material but from the use of a conical drill bit or from a deterioration in cutting conditions during drilling due, for example, to variable lubrication, chip jamming, etc.

In this respect, there is still room for improvement in techniques for drilling multilayer or non-multilayer materials.

### 4. SUMMARY

To this end, the invention proposes a method for drilling an element to be drilled by means of a cutting tool capable of being rotated and translated about/along the same axis by a drilling device, said device comprising:
a cutting motor capable of causing said cutting tool to rotate about said axis;
a feed motor capable of causing said cutting tool to translate along said axis; said method comprising at least:
a step of measuring a torque applied to said cutting tool around said axis;
a step of measuring a thrust applied to said cutting tool along said axis;
a step of comparing said torque with a predetermined torque threshold C;
a step of comparing said thrust with a predetermined thrust threshold P;
a step for adapting said motors control, said step for adapting causing that:
   said rotation and feed motors are speed-controlled as long as said torque and said thrust are below said torque threshold C and said thrust threshold P respectively;
   when said torque or thrust reaches or exceeds said torque threshold C or thrust threshold P, the motor generating the torque or thrust whose threshold has been exceeded is current-controlled, whereas the other motor is still speed-controlled, in such a way that the feed per revolution of said cutting tool is equal to a predetermined value ATR.

The invention consists in measuring, during a drilling operation, the torque and thrust applied to the cutting tool and to control the speed of the rotation and feed motors as long as the torque and thrust remain below predetermined thresholds. Then, when the torque or thrust exceeds a predetermined threshold, the motor generating the variable whose threshold has been exceeded, i.e. the cutting motor for torque and the feed motor for thrust, is torque-controlled, whereas the other motor is still speed-controlled so that the feed per revolution of the drill bit has a predetermined value.

This approach makes it possible, in real time, to adapt the cutting conditions when events occur during drilling, which leads to an increase in torque or thrust beyond acceptable values. Thus, the invention makes it possible to optimise a drilling operation and increase its quality, while preserving the equipment (cutting tool and drilling machine) used for this purpose.

The technique according to the invention can be implemented either for drilling a single-material element or an element comprising a stack of a plurality of layers of different materials.

According to one possible characteristic, said step for adapting said control, when one of the motors is current-controlled, comprises a step of determining a rotation frequency setpoint of said speed-controlled motor based on the rotation frequency of said current-controlled motor.

According to one possible characteristic, said rotation and feed motors are initially speed-controlled according to initial rotation frequencies. This is particularly true during the phase when the drill bit approaches the piece to be drilled.

According to one possible characteristic, when said torque reaches said torque threshold (C), said step for adapting said control comprises the following first sub-steps:
current controlling of said cutting motor so that said torque does not exceed said torque threshold (C);
measuring a new rotation frequency of said cutting motor;
determining a new rotation frequency of said feed motor such that the feed per revolution of said cutting tool is equal to said predetermined value (ATR);
controlling said feed motor so that it is driven at said new rotation frequency. (V″).

According to one possible characteristic, when said thrust reaches said thrust threshold (P), said step for adapting said control comprises the second following first sub-steps:
controlling said feed motor so that said thrust does not exceed said predetermined thrust threshold (P);
measuring a new rotation frequency (V″) of said feed motor;
determining a new rotation frequency (N″) of said cutting motor such that the feed per revolution of said cutting tool is equal to said predetermined value (ATR);
controlling said cutting motor so that it is driven at said new rotation frequency (N″).

According to one possible characteristic, said predetermined feed per revolution (ATR) of said cutting tool is:
constant, or
determined based on the rotation frequency of said cutting tool and/or the depth of engagement of said cutting tool.

According to one possible characteristic, said method comprises the steps of:
measuring and record in real time new rotation frequencies of said cutting and/or feed motor based on time, or
measuring and recording in real time a current consumed by said cutting and/or feed motor based on time;
comparing the recordings thus obtained with predetermined curves of variation based on the time of the rotation frequency of said cutting and/or feed motor or of a current consumed by said cutting and/or feed motor, said predefined curves corresponding to predetermined events and natures of events;
deducing from this comparison the occurrence of an event and its nature.

According to one possible characteristic, said nature belongs to the group comprising:
an entry of said cutting tool into said element to be drilled
an exit of said cutting tool from said element to be drilled,
the passing of said cutting tool through a new material, said element to be drilled comprising a stack of at least two different materials;
a chip jamming in a hole being drilled.

According to one possible characteristic, said motors are speed-controlled or current-controlled by the implementation of a vector control.

The invention also relates to a device for drilling an element to be drilled, said device comprising:
an output shaft capable of being rotated and translated about/along the same axis;
means for securing a cutting tool to said output shaft;
a cutting motor capable of causing said output shaft to rotate about said axis;
a feed motor capable of causing said output shaft to translate along said axis;
   said method comprising at least:
means for measuring a torque applied to said output shaft around said axis;
means for measuring a thrust applied to said output shaft along said axis;
means for comparing said torque with a predetermined torque threshold (C);
means for comparing said thrust with a predetermined thrust threshold (P);
means for adapting said motors control, said means for adapting being configured to cause that:
   said rotation and feed motors are speed-controlled as long as said torque and said thrust are below said torque threshold (C) and said thrust threshold (P) respectively;
   when said torque or thrust reaches or exceeds said torque threshold (C) or thrust threshold (P), the motor generating the torque or thrust whose threshold has been exceeded is current-controlled, whereas the other motor is still speed-controlled, in such a way that the feed per revolution of said cutting tool is equal to a predetermined value (ATR).

According to one possible characteristic, said means for adapting said control, when one of the motors is current-controlled, are configured to determine a rotation frequency setpoint of said speed-controlled motor based on the rotation frequency of said current-controlled motor.

According to one possible characteristic, said rotation and feed motors are initially speed-controlled according to initial rotation frequencies.

According to one possible characteristic, when said torque reaches said torque threshold (C), said means for adapting said control are configured to:
control the current of said cutting motor so that said torque does not exceed said torque threshold (C);
measure a new rotation frequency (N″) of said cutting motor;
determine a new rotation frequency (V″) of said feed motor such that the feed per revolution of said cutting tool is equal to said predetermined value (ATR);
control said feed motor so that it is driven at said new rotation frequency (V″).

According to one possible characteristic, when said thrust reaches said thrust threshold (P), said means for adapting said control are configured to:
control said feed motor so that said thrust does not exceed said predetermined thrust threshold (P);
measure a new rotation frequency (V″) of said feed motor;
determine a new rotation frequency (N″) of said cutting motor such that the feed per revolution of said cutting tool is equal to said predetermined value (ATR);
control said cutting motor so that it is driven at said new rotation frequency (N″).

According to one possible characteristic, said predetermined feed per revolution (ATR) of said cutting tool is:
constant, or
determined based on the rotation frequency of said cutting tool and/or the depth of engagement of said cutting tool.

According to one possible characteristic said device is configured for:
measure and record in real time new rotation frequencies of said cutting and/or feed motor based on time, or
measure and record in real time a current consumed by said cutting and/or feed motor based on time;
compare the recordings thus obtained with predetermined curves of variation based on the time of the rotation frequency of said cutting and/or feed motor or of a current consumed by said cutting and/or feed motor, said predefined curves corresponding to predetermined events and natures of events;
deduce from this comparison the occurrence of an event and its nature.

In this case, said nature preferably belongs to the group comprising:
an entry of said cutting tool into said element to be drilled;
an exit of said cutting tool from said element to be drilled;
the passing of said cutting tool through a new material, said element to be drilled comprising a stack of at least two different materials;
a chip jamming in a hole being drilled.

According to one possible characteristic, a device according to the invention comprises means for speed or current controlling of said motors, said means for controlling implementing a vector control.

The invention also relates to a computer program comprising program code instructions for executing the steps of the method for drilling according to any one of the variants presented above, when said program is executed by a processor.

The invention also relates to a computer-readable storage medium on which is saved a computer program comprising program code instructions for executing the steps of the method for drilling according to any one of the variants presented above, when said program is executed by a processor.

### 5. DESCRIPTION OF THE FIGURES

Other characteristics and advantages of the invention will emerge upon reading the following description of particular embodiments, provided as a simple non-restrictive illustrative example, and the annexed drawings, wherein:

FIG. 1 illustrates an example of drilling device according to the invention;

FIG. 2 illustrates an example of controller for the drilling device shown in FIG. 1;

FIG. 3 illustrates an example of vector control of a permanent magnet synchronous motor;

FIG. 4 illustrates a flowchart of an example of a method for drilling according to the invention;

FIG. 5 illustrates an example of curves for variation in speed of the cutting motor and for variation in torque during drilling of a stack of a layer of soft material and a layer of hard material;

FIG. 6 illustrates an example of curves for variation in speed of the cutting motor and for variation in torque during drilling of a stack of a layer of hard material and a layer of soft material;

FIG. 7 illustrates shows an example of curves for variation in the speed of the cutting motor and for variation in torque during drilling of a single-layer element with a conical drill bit;

FIG. 8 illustrates an example of curves for variation in speed of the cutting motor and for variation in torque during drilling-milling single-layer element with a drill bit adapted to a drilling of this type.

### 6. DESCRIPTION OF PARTICULAR EMBODIMENTS

### 6.1. Device

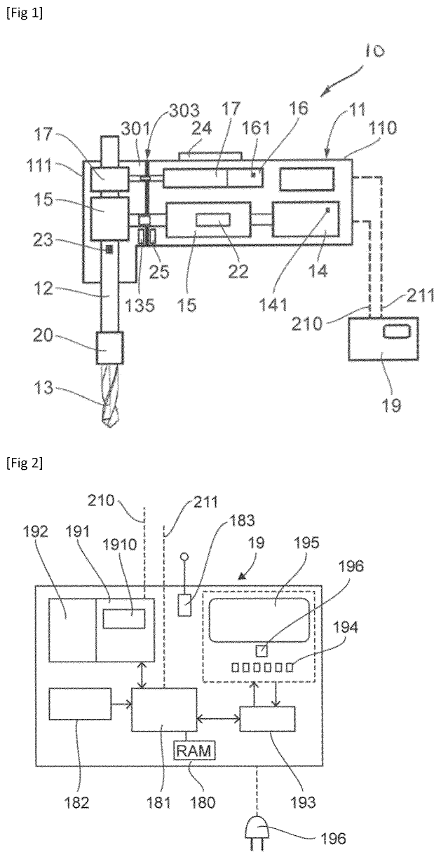

In relation to FIGS. 1 to 3, an example of a drilling device for implementing a method according to the invention is now presented.

As shown in FIG. 1, such a drilling device comprises:
a drilling machine 10 with controlled cutting parameters, and
a controller 19 configured to allow the implementation of a method according to the invention.

Such a drilling device is already known to a person skilled in the art and is not described in detail here, apart from the elements that are more specific to the invention.

Such a drilling machine 10 comprises a housing 11.

The housing 11 comprises a first casing portion 110 and a second casing portion 111 which substantially extend perpendicular to each other. In a variant, the housing could extend along a single axis and therefore not be essentially T-shaped.

The drilling machine comprises an output shaft 12, or spindle, rotated and translated about/along the same axis. This output shaft 12 is connected by means of one or more transmission chains to motor means.

In this embodiment, the driving means comprise:
a cutting motor 14 linked to the output shaft 12 by a transmission chain 15 enabling the output shaft 12, and therefore the cutting tool 13 secured to it, to be rotated, and
a feed motor 16, linked to the output shaft 12 by a transmission chain 17 enabling the output shaft 12, and therefore the cutting tool secured to it, to translated.

These motors are preferably permanent magnet synchronous electric motors. However, other types of suitable motors could also be used.

The spindle 12 is rotated and fed along the same axis so that the rotation frequency of the spindle (and of the cutting tool secured to it) is proportional to the rotation frequency of the cutting motor and the feed speed of the spindle (and of the cutting tool secured to it) is proportional to the rotation frequency of the feed motor. Such a principle is notably disclosed in the document FR3000693.

The drilling machine includes means for securing 20 a cutting tool 13, for example a drill bit, placed at the end of the spindle 12. These securing means may, for example, include a drill chuck. Naturally, these securing means can make it possible to secure a number of different drill bits to the drilling machine.

The drilling machine comprises means for measuring at least one item of information representative of the torque applied to the cutting tool along its rotation axis and means for measuring at least one item of information representative of the thrust applied to the cutting tool along its translation axis.

The means for measuring at least one item of information representative of the torque comprise one or the combination of several of the following means:
a torque sensor 22 applied to the drill bit along its rotation axis;
a current or electrical power sensor 1910 consumed by the cutting motor.

The means for measuring at least one item of information representative of the thrust comprise one or the combination of several of the following means:
an axial thrust sensor 23 capable of measuring the force applied to the drill bit along its rotation axis;
a current or electrical power sensor 1910 consumed by the feed motor.

The controller can be integrated into the housing of the drilling machine or connected to it by a cable which typically includes power supply wires 210 for the motors and possibly communication wires 211. It may also include tubes for carrying fluid(s) such as lubricant.

According to the embodiment shown in FIG. 2, the controller 19 comprises a random access memory 180 (for example a RAM memory), a processing unit 181 equipped for example with a processor, and driven by a computer program, comprising program code instructions for executing a drilling method according to the invention, this program being stored in a read-only memory 182 (for example a ROM memory). The controller also includes a wired or wireless transmission/reception module 183 enabling it to communicate with the drilling machine and possibly with other items of equipment such as a computer network, this transmission/reception module including:
a receiver for receiving signals delivered by the various measuring means (sensor) incorporated in the drilling machine;
a transmitter for transmitting commands to the drilling machine.

The drilling machine also includes a transmission/reception module (not shown) for communicating with the controller.

The controller also comprises an input/output interface 193, a user interface for managing a command input means 194 (keyboard, touch screen, mouse, etc.), a display means 195 (screen, display, indicator light) and, optionally, a means for transmitting a sound signal at an audible frequency 196.

The input/output interface can enable the programming of drilling strategies. The drilling machine itself can incorporate a human-machine interface 24 enabling drilling to be started and information relating to the drilling process to be displayed.

This controller 19 comprises two power supplies 191, 192 for powering the rotary drive motor 14 and the feed motor 16. These power supplies can, for example, be inverters controlled using a vector control structure suitable for powering permanent magnet synchronous motors. These motors are fitted with an angle sensor 141, 161 whose signal, representative of the angle of the rotor with respect to the stator, is used by the inverters to power the synchronous motors correctly.

The controller 19 includes a connector 196 for connection to a power supply of electric current. The controller is separate from the drilling machine.

At initialisation, the code instructions of the computer program are for example loaded into a random access memory 180 before being executed by the processor of the processing unit 181. The RAM 180 notably contains the appropriate formulas for calculating the various quantities determined during the implementation of the method. The processor of the processing unit 181 performs the various calculations required. It can then, for example, display the result, store it, transmit it to a network, compare it with one or more predetermined threshold values and, if necessary, control the screwing device accordingly, transmit a visual and/or audible alarm if required, etc.

FIG. 2 only shows a particular one of several possible ways of realising a controller, so that it executes the steps of the drilling method according to the invention (in any of the various embodiments, or in a combination of these embodiments). Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the controller is realised with a reprogrammable computing machine, the corresponding program (i.e. the sequence of instructions) can be stored in a removable (such as, for example, a floppy disk, CD-ROM or DVD-ROM) or non-removable storage medium, this storage medium being partially or totally readable by a computer or a processor. It is also possible that the software is already loaded in the controller and certain options can be unlocked using a code obtained online, or that the software can be obtained online.

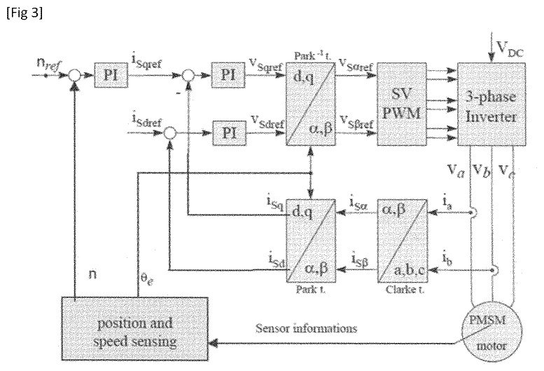

The controller 19 incorporates means for vector control of the motors. FIG. 3 shows a diagram of an example of vector control. Two controls of this type are therefore implemented, one to control the cutting motor, the other to control the feed motor.

The general principle of a vector control is to control the speed of the motor based on:
a setpoint speed control nref, and
a setpoint current control isdref defining the flux in the motor and generally set to zero.

These controls both incorporate a controller.

The speed control nref is followed by a setpoint current control isqref which remains inactive as long as the current component isq remains below the setpoint isqref.

The electromagnetic torque of the motor is equal to the product of the component isq and the torque constant Kt of the motor.

This cascade control therefore enables the motor to be controlled in terms of speed at a level nref as long as the resistive torque opposing the motor remains below the value Isqref.Kt, then if the resistive torque reaches Isqref.Kt, the control is a current control with isqref as the setpoint. As a result, the motor becomes controlled to produce a constant torque and its speed is set at a lower level than nref.

According to the invention, the motors are speed-controlled by default. However:
when the torque reaches a predetermined threshold, the current of the cutting motor is controlled and speed of the feed motor is controlled, and
when the thrust reaches a predetermined threshold, the current of the feed motor is controlled and the speed of the cutting motor is controlled.

This principle will furthered detailed below in connection with the description of a method according to the invention.

### 6.2 Definitions and Abbreviations

For clarity, certain physical quantities involved in the implementation of a technique according to the invention are presented below.

The following table lists, for the cutting motor and the feed motor, the name of the setpoints applied to the motor in real time depending on whether it is speed-controlled or current-controlled (torque), as well as the maximum values of these setpoints.

| | Setpoints in | Maximum |
|---|---|---|
| | real time | setpoint value |
| Cutting motor speed control | ncref (variable) | n (rpm) |
| Cutting motor current control | isqcref (invariable) | c (A) |
| Feed motor speed control | naref (variable) | v (rpm) |
| Feed motor current control | isqaref (invariable) | p (A) |

When considering the vector control schema in FIG. 3 to control the cutting motor, nref should be replaced by ncref, isqref should be replaced by isqcref.

When considering the vector control schema in FIG. 3 to control the feed motor, nref should be replaced by naref, isqref should be replaced by isqaref.

The table below lists the names of the various parameters involved in the implementation of the technique according to the invention.

| | |
|---|---|
| Maximum drill bit rotation speed | N (rpm) |
| Maximum torque applied to the drill bit | C (N · mm) |
| Maximum drill bit feed speed | V (mm/mn) |
| Maximum thrust applied to the drill bit | P (N) |
| Drill bit rotation speed in real time | N′ (rpm) |
| Drill bit feed speed in real time | V ′(mm/mn) |
| Cutting motor rotation speed in real time | N′′ (rpm) |
| Feed motor rotation speed in real time | V′′ (rpm) |
| Depth of engagement of the drill bit | depth (mm) |
| Wall thickness | E (mm) |

The principle on which the invention is based aims to control the motors so that the drill bit moves at a predetermined feed per revolution ATR.

At a given instant, ATR=V′/N′

Where: N″=K1.N′

V″=K2.V′

Thus: ATR=(V″.K1)/(K2.N″)

The usual unit of feed per revolution is mm/rev.

### 6.3 Method

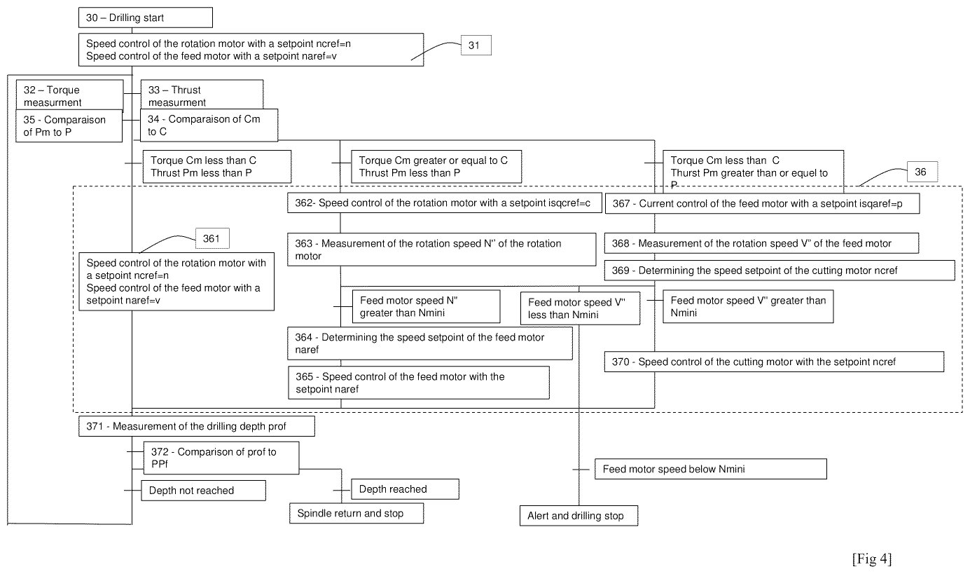

In relation to FIG. 4, an example of a method according to the invention of an element to be drilled, which may or may not consist of a plurality of layers of different materials, is described below.

Such a drilling method according to the invention aims to adapt the cutting parameters automatically based on the drilling conditions by adapting the control mode of the motors, while guaranteeing that the feed per revolution of the cutting tool conforms to a predetermined value.

Before carrying out a drilling operation, the technician in charge of programming the drilling machine must choose the parameters according to which the drilling is to be carried out, including:
the rotation speed of the cutting motor, whose setpoint is ncref, at which drilling will be started, knowing that the speed control mode of the motors is the default mode as long as the load on the motors remains below a given threshold.
the feed per revolution, ATR, strategy of the drill bit can be constant or depend on the depth of engagement of the cutting tool or the rotation speed of the cutting motor. This strategy makes the rotation speeds of the cutting and feed motors interdependent, thus if ncref is fixed then naref is derived in such a way that naref=ATR. ncref. The depth of engagement of the drill is the distance between the tip of the drill bit and the surface of the wall at the entrance to the hole in real time.
the thresholds of the load values (C) and (P) on the cutting tool, in torque and thrust, above which the control mode on the motors changes from speed control to torque control. Preferably, the cutting threshold C and the thrust threshold P will be associated with tolerance intervals.

The method described is applicable to the drilling of a wall made of one or more materials.

At the start of a drilling operation (step 30), the controller initially controls, based on two setpoints ncref and naref, the cutting and feed motors in terms of speed and preferably in a vectorial manner (step 31).

The rotation and feed motors are thus controlled in such a way that their rotation frequencies reach the setpoints ncref and naref respectively, the values of which are initially n and v respectively.

The method comprises a step 32 of measuring in real time at least one load value representative of the torque applied to the cutting tool and a step 33 of measuring in real time at least one load value representative of the thrust applied to the cutting tool. Examples of load values have been given above. For simplicity, we will use the expressions torque measurement and thrust measurement instead of measurement of at least one value representative of torque and measurement of at least one value representative of thrust.

The method comprises a step 34 of comparing in real time the measured torque Cm with a predetermined torque threshold C and a step 35 of comparing in real time the measured thrust Pm with a predetermined thrust threshold P.

The method comprises a step 36 of adapting the control of the cutting or feed motors based on the result of the comparison of the measured torque Cm and the measured thrust Pm respectively with the torque C and thrust P thresholds. The step 36 of adapting means that:
the cutting and feed motors are speed-controlled as long as the torque Cm and the thrust Pm are below the torque threshold C and the thrust threshold P respectively;
when the measured torque Cm or the measured thrust Pm reaches or exceeds the torque threshold C or thrust threshold P, the motor generating the torque or thrust whose threshold has been exceeded is current-controlled, whereas the other motor is still speed-controlled, in such a way that the feed per revolution of the cutting tool is equal to a predetermined value.

As long as the measured torque Cm and the measured thrust Pm remain below the torque C and thrust P thresholds, the controller continues (step 361) to control the speed of the cutting and feed motors respectively according to the setpoints of rotation frequency ncref=n of the cutting motor and of rotation frequency naref=v of the feed motor. The cutting tool therefore continues to be driven at the same feed per revolution ATR.

If, during drilling, the measured torque Cm becomes equal to the torque threshold C, the controller no longer controls the cutting motor in speed but in torque (current), while it continues to control the feed motor in speed.

In this case, the step 36 of adapting the control comprises the following sub-steps:
sub-step 362 for controlling the speed of the cutting motor with a setpoint isqcref=c so that the torque applied to the cutting tool does not exceed the torque threshold C;
sub-step 363 for measuring the new rotation frequency N″ of the cutting motor resulting from the control of its couple;
sub-step 364 for determining the new rotation frequency V″ of the feed motor and the corresponding setpoint naref accordingly such that the feed per revolution of the cutting tool is equal to the predetermined value of feed per revolution;
sub-step 365 for speed control of the feed motor with the setpoint naref so that it is driven at the new rotation frequency V″.
Optionally, the method comprises, after the sub-step 363 of measuring the new rotation frequency N″, a sub-step of comparing N″ with a predetermined value Nmini. If the new rotation frequency N″ is less than Nmini, the drilling operation in progress is stopped, preferably with the transmission of a warning message. Otherwise, the drilling operation in progress continues by controlling the feed motor so that it is driven at the new rotation frequency V″.

If, during drilling, the measured thrust Pm becomes equal to the thrust threshold P, the controller no longer controls the feed motor in speed but in torque (current), while it continues to control the cutting motor in speed.

In this case, the step 36 of adapting the control comprises the following sub-steps:
sub-step 367 of controlling the speed of the feed motor with a setpoint isqaref so that the thrust Pm does not exceed the determined thrust threshold P;
sub-step 368 of measuring the new rotation frequency V″ of the feed motor;
sub-step 369 of determining the new rotation frequency N″ and the speed setpoint ncref pf the cutting motor such that the feed per revolution of the cutting tool is equal to the predetermined value;
sub-step 370 of speed control of the cutting motor with the setpoint ncref so that it is driven at the new rotation frequency N″.
Optionally, the method comprises, after the sub-step 369 of determining the new speed setpoint ncref, a sub-step of comparing ncref with a predetermined value Nmini. If the new rotation setpoint ncref is less than Nmini, the drilling operation in progress is stopped, preferably with the transmission of a warning message. Otherwise the drilling operation in progress continues by controlling the cutting motor so that it is driven at the new rotation frequency N″.

The method comprises a step 371 of measuring in real time the drilling depth prof (depth of engagement of the drill bit in the hole) and a step 372 of comparing in real time the measured drilling depth prof with a predetermined final drilling depth threshold PPf corresponding to the drilling depth to be achieved. As long as the measured drilling depth prof is below the predetermined final drilling depth threshold PPf, the drilling operation continues. When the measured drilling depth prof reaches the predetermined final drilling depth threshold PPf, the cutting tool is retracted and the drilling operation is stopped.

Several strategies can be implemented to determine the value of the predetermined feed per revolution ATR. They are given by way of example to illustrate and offers the possibility of combinations or variations.

### Strategy 1: Constant Feed Per Revolution

The first strategy is to adapt the control system so that the ATR remains constant. In this case, the predetermined feed per revolution selected before the start of a drilling operation is maintained so that the value taken into account for the feed per revolution during the step of adapting the motor control remains the same.

In this case, the feed per revolution remains constant so that:

$$ATR = V / N = {V}^{′} / {N}^{′} = {V}^{″} / {N}^{″}$$

As a result, the motor setpoints are as shown in the table below.

| Strategy for feed | | Cutting motor | |
|---|---|---|---|
| per revolution 1 | | Speed control | Current control |
| Feed | Speed control | ncref = n | isqcref = c |
| motor | | naref = v | naref = v · N′/N |
| | Current control | ncref = n · V′/V | Not applicable |
| | | isqaref = p | |

### Strategy 2: Variable Feed Per Revolution Based on the Rotation Speed of the Cutting Tool

In the second strategy, the feed per revolution of the drill bit depends on the speed of rotation N of the cutting tool. In this case, different values of a coefficient A2 are associated with different rotation speed ranges N of the cutting tool. The table below gives illustrative examples of values of A2 for values of N′.

| N′ | A2 |
|---|---|
| 6,000 to | 0.1 |
| 12,000 | |
| 1800 to 6000 | 0.08 |
| 500 to 1800 | 0.05 |

In this case, the motor setpoints are as shown in the table below.

| Strategy for feed | | Cutting motor | |
|---|---|---|---|
| per revolution 2 | | Speed control | Current control |
| Feed | Speed control | ncref = n | isqcref = c |
| motor | | naref = v | naref = K2 · N′ · A2 |
| | Current control | ncref = K1 · V′/A2 | Not applicable |
| | | isqaref = p | |

In the case of current control of the feed motor followed by calculation of the speed control setpoint of the cutting motor, the speed of the cutting motor not being known in principle, the following sequences will be carried out:
selection of a feed per revolution in the table.
calculation of the rotation speed setpoint of the cutting motor and the resulting rotation speed of the drill bit.
comparison of the rotation speed value of the cutting tool with the speed range associated with the selected feed per revolution.
if the range in question contains the calculated speed, then the cutting motor is speed-controlled with the calculated setpoint.
if the range in question does not contain the calculated speed, then the next feed per revolution in the table is taken into account for a new cutting motor speed setpoint calculation. This calculation is repeated until the calculated speed is consistent with the speed range in question.

### Strategy 3: Variable Feed Per Revolution Based on the Depth of Engagement of the Cutting Tool

In strategy 3, the feed per revolution depends on the depth of engagement of the cutting tool based on the function: ATR=A3.(2.E-prof)/2.E

This results in a feed of A3 at the entry point to the hole and A3/2 at the exit point, after the drill bit has covered a depth of E mm (wall thickness).

In this case, the motor setpoints are as shown in the table below.

| Strategy for feed | | Cutting motor | |
|---|---|---|---|
| per revolution 2 | | Speed control | Current control |
| Feed | Speed control | ncref = n | isqcref = c |
| motor | | naref = v | naref = K2 · N′ · A3 · |
| | | | (2 · E-prof)/2 · E |
| | Current control | ncref = K1 · V′ · 2 · E/ | Not applicable |
| | | A3 · (2 · E-prof)/2 · E | |
| | | isqaref = p | |

### Example of Motor Control Curves

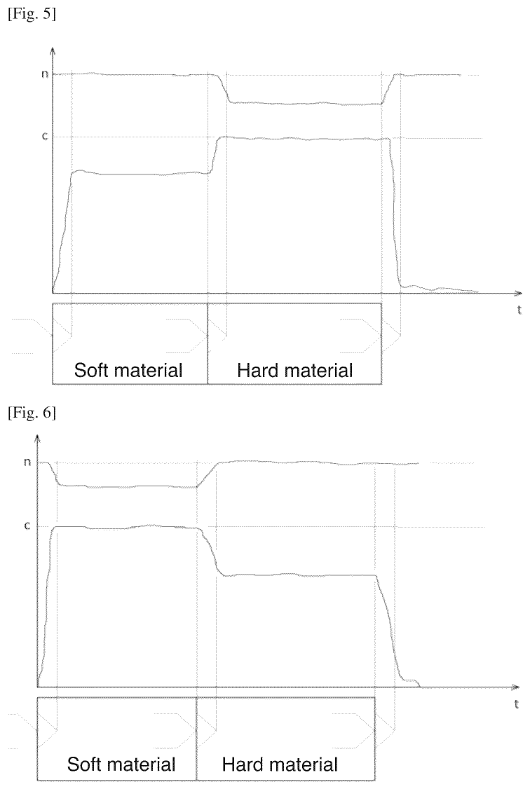

FIGS. 5, 6, 7 and 8 show examples of curves for variation in speed n of the cutting motor and variation in torque c during respectively:
drilling the stack of a layer of soft material and a layer of hard material;
piercing the stack of a layer of hard material and a layer of soft material;
drilling a single-layer element with a conical drill bit;
drilling-milling a single-layer element using a drill bit adapted to this type of drilling.

It is observed in FIG. 5 that after the drill bit has fully entered the soft material, the torque c stabilises at a value below the torque threshold C, so that the rotation motor is speed-controlled with n=ncref. After the drill bit has entered the hard material, the torque c increases, so that the rotation motor is torque-controlled in order for the torque to stabilise at the torque threshold C.

It is observed in FIG. 6 that after the drill bit has entered the hard material, the torque c increases so that the rotation motor is torque-controlled in order for the torque to stabilise at the torque threshold C. After the drill bit has fully entered the soft material, the torque c stabilises at a value below the torque threshold C, so that the rotation motor is speed-controlled with n=ncref.

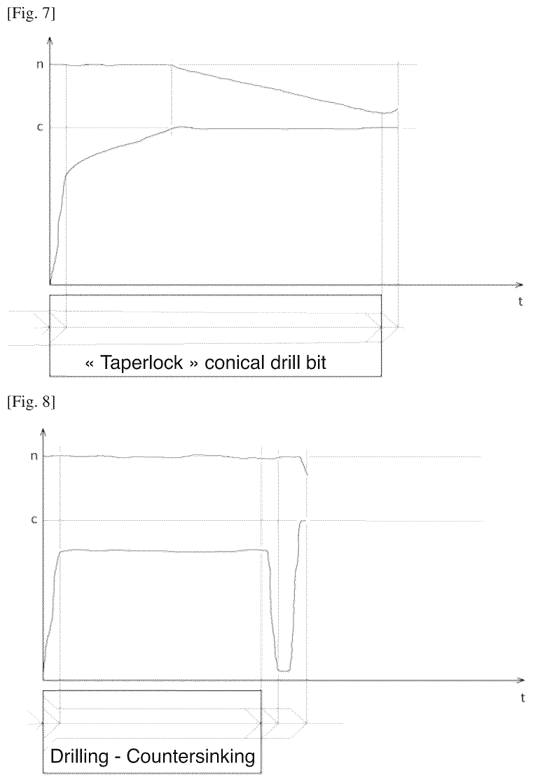

It is observed in FIG. 7 that the rotation motor is initially speed-controlled with n=ncref and that, after the drill bit has entered the material, the torque c increases so that, beyond a given value, the rotation motor is torque-controlled in order for the torque to stabilise at the torque threshold C.

It is observed in FIG. 8 that the rotation motor is initially speed-controlled with n=ncref and that, after the drill bit has entered the material, the torque c stabilises at a value below the threshold C. Then, when the drill bit emerges from the piece to be drilled, the torque C decreases significantly before increasing again when the countersink is made, so that the rotation motor is torque-controlled in order for the torque to stabilise at the torque threshold C.

### Identification of Events During Drilling

In a variant, the method comprises steps of:
measuring and recording in real time new rotation frequencies N″, V″ of the cutting and/or feed motor based on time, or
measuring and recording in real time a current consumed by the cutting and/or feed motor based on time;
comparing the recordings thus obtained with predetermined curves of variation based on the time of the rotation frequency of the cutting and/or feed motor or on a current consumed by the cutting and/or feed motor, the predefined curves corresponding to predetermined events and natures of events;
deducing from this comparison the occurrence of an event and its nature.

The nature of the detectable events preferably belongs to the group comprising:
an entry point of said cutting tool into said element to be drilled
an exit point of said cutting tool from said element to be drilled,
the passing of said cutting tool through a new material, said element to be drilled comprising a stack of at least two different materials;
a chip jamming in a hole being drilled.

The identification of the event can, for example, be based on the implementation of the technique described in patent application FR2103983.

An exemplary aspect of the present disclosure provides an effective solution to at least some of the different problems discussed in the Prior Art section.

In particular, an exemplary aspect provides a drilling technique that enables to optimize a drilling.

In particular, an exemplary aspect provides such a technique which helps to optimize drilling by adapting to the various problems likely to be encountered during this drilling.

Another exemplary aspect provides such a technique which enables a reactive response to the occurrence of an event during a drilling operation in order to optimise its execution.

Another exemplary aspect supplies such a technique that is simple.

1. A method for drilling an element to be drilled by using a cutting tool capable of being rotated and translated about/along a same axis by a drilling device, said device comprising:
a cutting motor capable of causing said cutting tool to rotate about said axis;
a feed motor capable of causing said cutting tool to translate along said axis;
said method comprising:
measuring a torque applied to said cutting tool around said axis;
measuring a thrust applied to said cutting tool along said axis;
comparing said torque with a predetermined torque threshold;
comparing said thrust with a predetermined thrust threshold;
a step for adapting control of said motors so that:
said rotation and feed motors are speed-controlled as long as said torque and said thrust are below said torque threshold and said thrust threshold respectively; and
when said torque or thrust reaches or exceeds said torque threshold or thrust threshold the motor generating the torque or thrust whose threshold has been exceeded is current-controlled, whereas the other motor is still speed-controlled that a feed per revolution of said cutting tool is equal to a predetermined value.

2. The method for drilling according to claim 1 wherein said adapting said control, when one of the motors is current-controlled, comprises determining a rotation frequency setpoint of said speed-controlled motor based on a rotation frequency of said current-controlled motor.

3. The method for drilling according to claim 1 wherein said rotation and feed motors are initially speed-controlled according to initial rotation frequencies.

4. The method for drilling according to claim 1 wherein, in response to said torque reaching said torque threshold, said adapting said control comprises:
current controlling said cutting motor so that said torque does not exceed said torque threshold;
measuring a new rotation frequency of said cutting tool;
determining a new rotation frequency of said feed motor such that the feed per revolution of said cutting tool is equal to said predetermined value;
controlling said feed motor so that the feed motor is driven at said new rotation frequency.

5. The method for controlling according to claim 1 wherein, in response to said thrust reaching said thrust threshold, said adapting said control comprises:
controlling said feed motor so that said thrust does not exceed said predetermined thrust threshold;
measuring a new rotation frequency of said feed motor;
determining a new rotation frequency of said cutting motor such that the feed per revolution of said cutting tool is equal to said predetermined value;
controlling said cutting motor so that the cutting motor is driven at said new rotation frequency .

6. The method for drilling according to claim 1 wherein said predetermined feed per revolution of said cutting tool is:
constant, or
determined based on a rotation frequency of said cutting tool and/or a depth of engagement of said cutting tool.

7. The method for drilling according to claim 1, said method comprising:
measuring and recording in real time new rotation frequencies of said cutting and/or feed motor based on time, or
measuring and recording in real time a current consumed by said cutting and/or feed motor based on time;
comparing the recordings thus obtained with predetermined curves of variation based on a time of a rotation frequency of said cutting and/or feed motor or of a current consumed by said cutting and/or feed motor, said predefined curves corresponding to predetermined events and natures of events;
deducing from this comparison an occurrence of an event and its nature.

8. The method for drilling according to claim 7 wherein said nature belongs to the group consisting of:
an entry of said cutting tool into said element to be drilled
an exit of said cutting tool from said element to be drilled,
a passing of said cutting tool through a new material, said element to be drilled comprising a stack of at least two different materials;
a chip jamming in a hole being drilled.

9. The method for drilling according to claim 1 wherein said motors are speed-controlled or current controlled by using a vector control.

10. A device for drilling an element to be drilled, said device comprising:
an output shaft capable of being rotated and translated about/along the same axis;
means for securing a cutting tool to said output shaft;
a cutting motor capable of causing said output shaft to rotate about said axis;
a feed motor capable of causing said output shaft to translate along said axis;
said device comprising a controller programmed to perform a method comprising:
measuring a torque applied to said output shaft around said axis;
measuring a thrust applied to said output shaft along said axis;
comparing said torque with a predetermined torque threshold;
comparing said thrust with a predetermined thrust threshold;
adapting control of said motors, said adapting being configured so that:
said rotation and feed motors are speed-controlled as long as said torque and said thrust are below said torque threshold and said thrust threshold respectively; and
when said torque or thrust reaches or exceeds said torque threshold or thrust threshold the motor generating the torque or thrust whose threshold has been exceeded is current-controlled, whereas the other motor is still speed-controlled so that a feed per revolution of said cutting tool is equal to a predetermined value.

11. The device for drilling according to claim 10 wherein said adapting said control, when one of the motors is current-controlled, comprises determining a rotation frequency setpoint of said speed-controlled motor based on a rotation frequency of said current-controlled motor.

12. The device for drilling according to claim 10 wherein said rotation and feed motors are initially speed-controlled according to initial rotation frequencies.

13. The device for drilling according to claim 10 wherein, the controller is programmed to, in response to said torque reaching said torque threshold;
current-control said cutting motor so that said torque does not exceed said torque threshold;
measure a new rotation frequency of said cutting motor;
determine a new rotation frequency of said feed motor such that the feed per revolution of said cutting tool is equal to said predetermined value;
control said feed motor so that the feed motor is driven at said new rotation frequency.

14. The device for drilling according to claim 10 wherein the controller is programmed to, when said thrust reaches said thrust threshold:
control said feed motor so that said thrust does not exceed said predetermined thrust threshold:
measure a new rotation frequency of said feed motor;
determine a new rotation frequency of said cutting motor such that the feed per revolution of said cutting tool is equal to said predetermined value;
control said cutting motor so that the cutting motor is driven at said new rotation frequency.

15. The device for drilling according to claim 10 wherein said predetermined feed per revolution of said cutting tool is:
constant, or
determined based on a rotation frequency of said cutting tool and/or a depth of engagement of said cutting tool.

16. The device for drilling according to claim 10, said device being configured to:
measure and record in real time new rotation frequencies of said cutting and/or feed motor based on time, or
measure and record in real time a current consumed by said cutting and/or feed motor based on time;
compare the recordings thus obtained with predetermined curves of variation based on a time of a rotation frequency of said cutting and/or feed motor or of a current consumed by said cutting and/or feed motor, said predefined curves corresponding to predetermined events and natures of events;
deduce from this comparison an occurrence of an event and its nature.

17. The device for drilling according to claim 16 wherein said nature belongs to the group consisting of:
an entry of said cutting tool into said element to be drilled;
an exit of said cutting tool from said element to be drilled;
passing of said cutting tool through a new material, said element to be drilled comprising a stack of at least two different materials;
a chip jamming in a hole being drilled.

18. The device for drilling according to claim 10 comprising means for speed or current controlling of said motors, said means for controlling implementing a vector control.

19. (canceled)

20. A non-transitory computer-readable storage medium with a computer program recorded thereon which when executed by a processor of a drilling device configure the drilling device to implement a method for drilling an element to be drilled by using a cutting tool capable of being rotated and translated about/along a same axis by the drilling device, the drilling device comprising:
a cutting motor capable of causing said cutting tool to rotate about said axis;
a feed motor capable of causing said cutting tool to translate along said axis;
the method comprising:
measuring a torque applied to said cutting tool around said axis;
measuring a thrust applied to said cutting tool along said axis;
comparing said torque with a predetermined torque threshold;
comparing said thrust with a predetermined thrust threshold;
adapting control of said motors so that:
said rotation and feed motors are speed-controlled as long as said torque and said thrust are below said torque threshold and said thrust threshold respectively; and
when said torque or thrust reaches or exceeds said torque threshold or thrust threshold the motor generating the torque or thrust whose threshold has been exceeded is current-controlled, whereas the other motor is still speed-controlled so that a feed per revolution of said cutting tool is equal to a predetermined value.
